(19) United States
(12) Patent Application Publication
(10) Pub. No.: US 2016/0359276 A1
(43) Pub. Date: Dec. 8, 2016

(54) PLUG CONNECTOR, JACK CONNECTOR, AND CONNECTOR DEVICE

(71) Applicant: FUJITSU COMPONENT LIMITED, Tokyo (JP)

(72) Inventors: Yasuyuki MIKI, Tokyo (JP); Mitsuru Kobayashi, Tokyo (JP)

(73) Assignee: FUJITSU COMPONENT LIMITED, Tokyo (JP)

(21) Appl. No.: 15/244,492

(22) Filed: Aug. 23, 2016

Related U.S. Application Data
(62) Division of application No. 14/308,036, filed on Jun. 18, 2014.

(30) Foreign Application Priority Data
Aug. 19, 2013 (JP) 2013-169652

(51) Int. Cl. H01R 13/6471; H01R 12/73; H01R 12/71

(52) U.S. Cl. CPC H01R 13/6471; H01R 12/716; H01R 12/73

(57) ABSTRACT

A plug connector includes a housing including a first wall and a second wall; first signal contacts aligned along the first wall; second signal contacts aligned along the second wall; and a plate-shaped ground contact disposed between the first signal contacts and the second signal contacts. Each of the first signal contacts includes a contact point on one side facing the ground contact coming into conductive contact with a signal contact of a counterpart connector, and is fixedly supported by the first wall on the other side. Each of the second signal contacts includes a contact point on one side facing the ground contact coming into conductive contact with a signal contact of the counterpart connector, and is fixedly supported by the second wall on the other side.

### CROSS-REFERENCE TO RELATED APPLICATIONS

This application is a divisional of U.S. patent application Ser. No. 14/308,036 filed on Jun. 18, 2014 which is based upon and claims the benefit of priority of the prior Japanese Application No. 2013-169652, filed on Aug. 19, 2013, the entire contents of which are incorporated herein by reference.

### BACKGROUND OF THE INVENTION

1. Field of the Invention

The present invention relates to a plug connector, a jack connector, and a connector device.

2. Description of the Related Art

There are various known connector devices provided with a jack connector and a plug connector to be connected to the jack connector, and configured to be mounted on a printed substrate (for example, Publication of Examined Utility Model Application No. S49-6543, Japanese Laid-open Patent Publication No. H05-135826, Japanese Laid-open Patent Publication No. H08-241762).

In the technical field of connector devices described above, there is a demand for implementing high-speed transmission of a signal between connector devices, and miniaturizing a connector device.

### SUMMARY OF THE INVENTION

According to an aspect of the invention, a plug connector is provided with a housing including a first wall and a second wall; first signal contacts aligned along the first wall; second signal contacts aligned along the second wall; and a plate-shaped ground contact disposed between the first signal contacts and the second signal contacts so as to face the first signal contacts and the second signal contacts. Each of the first signal contacts includes a first contact point on one side facing the ground contact, and is fixedly supported by the first wall on the other side. Further, each of the second signal contacts includes a contact point on one side facing the ground contact, and is fixedly supported by the second wall on the other side.

### DESCRIPTION OF DRAWINGS

FIG. 1 is a perspective view of a plug connector according to an embodiment of the invention;

FIGS. 2A to 2E are external views of the plug connector illustrated in FIG. 1;

FIG. 3 is an exploded perspective view of the plug connector illustrated in FIG. 1;

FIG. 4 is a cross-sectional view taken along the line IV-IV in FIG. 2A;

FIGS. 5A to 5E are external views of a signal contact illustrated in FIG. 3;

FIG. 6 is a perspective view of a jack connector according to an embodiment of the invention;

FIGS. 7A to 7E are external views of the jack connector illustrated in FIG. 6;

FIG. 8 is an exploded perspective view of the jack connector illustrated in FIG. 6;

FIG. 9 is a cross-sectional view taken along the line VIII-VIII in FIG. 7A;

FIGS. 10A and 10B are external views of a ground contact illustrated in FIG. 8;

FIGS. 11A to 11E are external views of a signal contact illustrated in FIG. 8;

FIG. 12 is a cross-sectional view of a connector device according to an embodiment of the invention; and

FIGS. 13A to 13C are diagrams illustrating ground contacts of the jack connector according to other embodiments.

### DETAILED DESCRIPTION

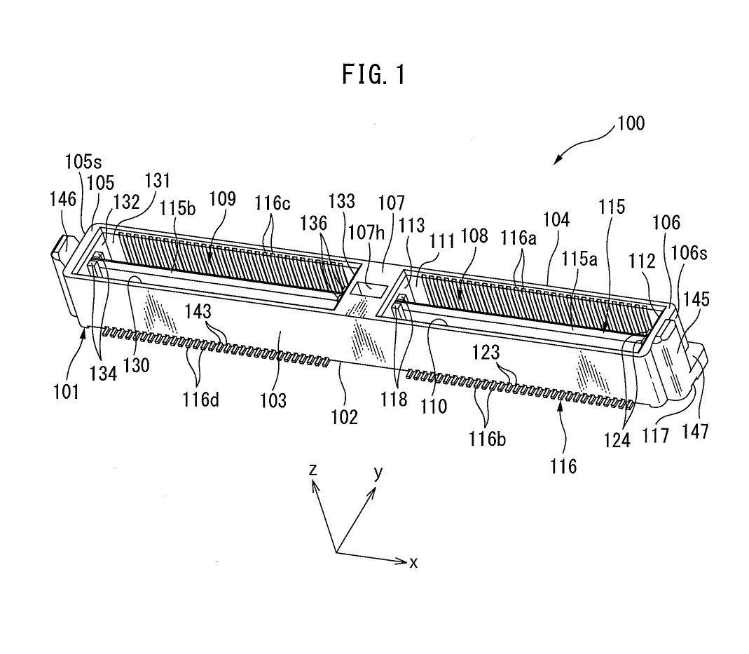

In the following, embodiments of the invention are described in detail based on the drawings. First of all, a configuration of a plug connector 100 according to an embodiment of the invention is described referring to FIGS. 1 to 4. In the following description, as illustrated in FIG. 1, the length direction (long side direction) of a housing 101 is defined as x-axis direction, the width direction (short side direction) thereof is defined as y-axis direction, and the height direction thereof is defined as z-axis direction; and the directions indicated by the arrows of x-axis, y-axis, and z-axis are referred to as positive directions.

The plug connector 100 is provided with the housing 101, a ground contact 115, and signal contacts 116. The ground contact 115 and the signal contacts 116 are mounted in the housing 101. The housing 101 is provided with a bottom wall 102, and side walls 103 and 104 disposed on both ends of the bottom wall 102 in y-axis direction and extending along x-axis in parallel to each other. The side wall 103 is disposed separately from the side wall 104 in the negative y-axis direction.

Further, the housing 101 is provided with a lateral wall 105 orthogonally intersecting with both of the side walls 103 and 104 at the ends of the side walls 103 and 104 in the negative x-axis direction, and a lateral wall 106 orthogonally intersecting with both of the side walls 103 and 104 at the ends of the side walls 103 and 104 in the positive x-axis direction.

Further, the housing 101 is provided with a partition wall 107 orthogonally intersecting with both of the side walls 103 and 104 at the middle in x-axis direction of the side walls 103 and 104. An opening 107h extending through the partition wall 107 in z-axis direction is formed in the middle part of the partition wall 107. The function of the opening 107h will be described later.

The housing 101 is provided with a first engaging unit 108 and a second engaging unit 109. The engaging units 108 and 109 are configured such that each of the engaging units 108 and 109 includes the side walls 103 and 104, and such that the engaging units 108 and 109 are adjacent to each other in x-axis direction. The engaging units 108 and 109 are separated from each other by the partition wall 107 in the region of the housing 101 on the positive x-axis side and in the region of the housing 101 on the negative x-axis side.

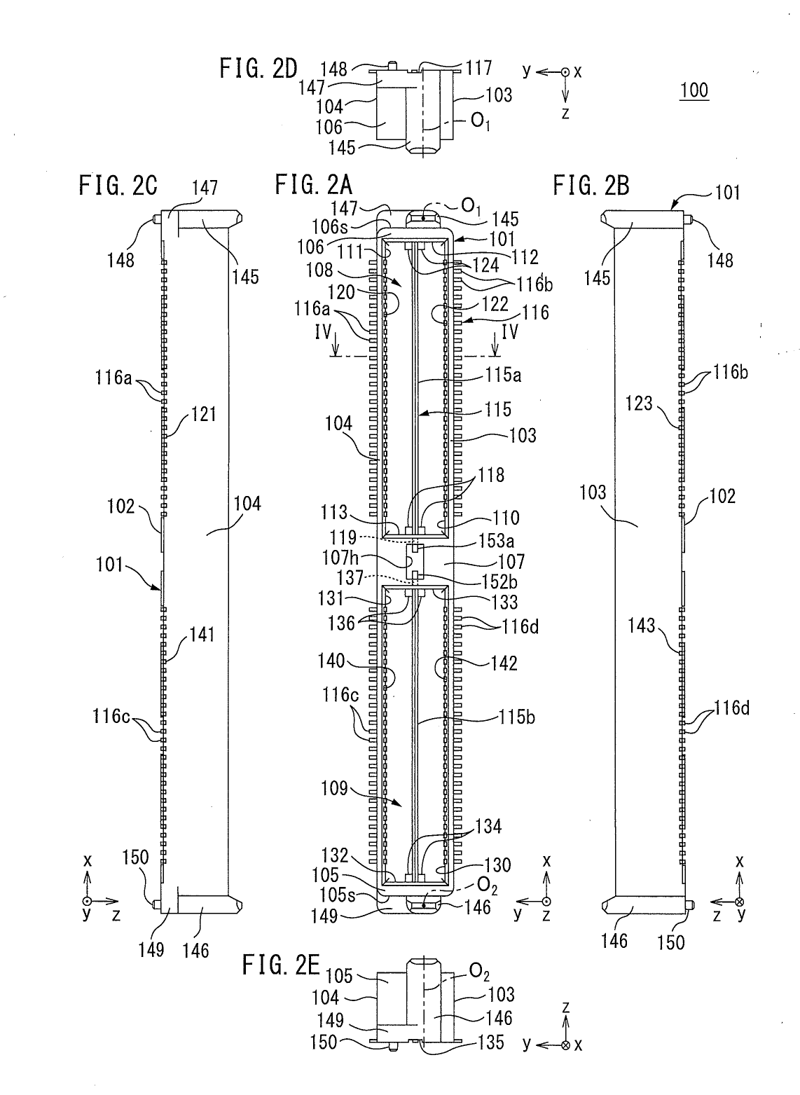

The engaging unit 108 is defined by an inner surface 110 of the side wall 103, an inner surface 111 of the side wall 104, an inner surface 112 of the lateral wall 106, and an inner surface 113 of the partition wall 107 on the positive x-axis side. A ground plate mounting part 124 (see FIG. 2A) are formed on the inner surface 112 of the lateral wall 106. The ground plate mounting part 124 includes a pair of protrusions extending in z-axis direction to be separate from each other in y-axis direction.

A through-hole 117 extending through the lateral wall 106 in x-axis direction is formed on the end of the ground plate mounting part 124 in the negative z-axis direction. A ground plate mounting part 118 is formed on the inner surface 113 of the partition wall 107.

The ground plate mounting part 118 includes a pair of protrusions extending in z-axis direction to be separate from each other in y-axis direction, in the same manner as the ground plate mounting part 124. Further, a through-hole 119 (see FIG. 2A) extending through the partition wall 107 in x-axis direction is formed from the inner surface 113 to the opening 107h between the paired protrusion of the ground plate mounting part 118. The opening 107h is disposed at the end of the inner surface 113 in z-axis direction.

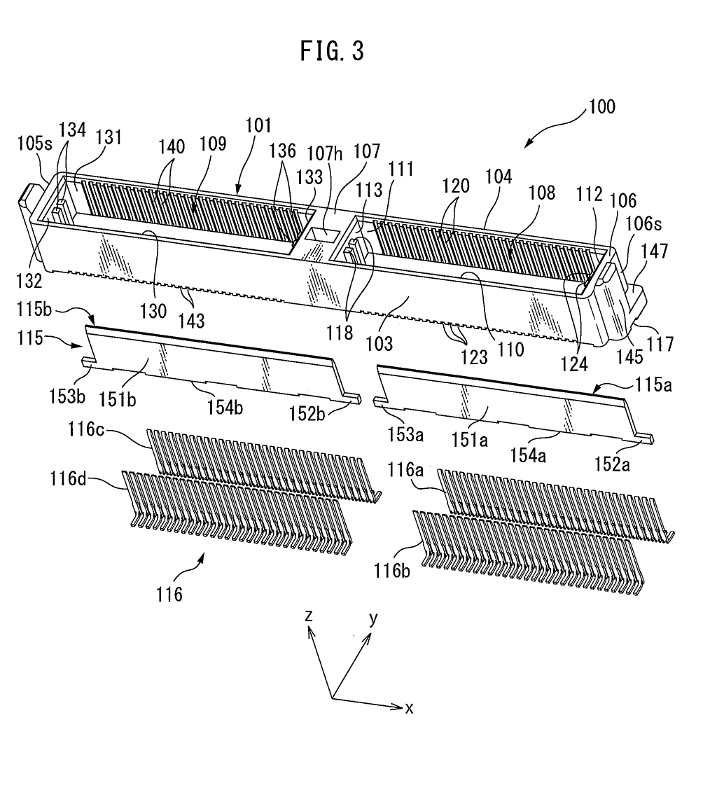

A plurality of signal contact mounting grooves 120 (see FIG. 3) are formed on the inner surface 111 of the side wall 104 so as to align along the inner surface 111. The signal contact mounting groove 120 is a groove formed to be concave from the inner surface 111 toward inward of the side wall 104 with a predetermined width, and extends along z-axis direction of the inner surface 111. The signal contact mounting grooves 120 are formed to align substantially equidistantly in x-axis direction.

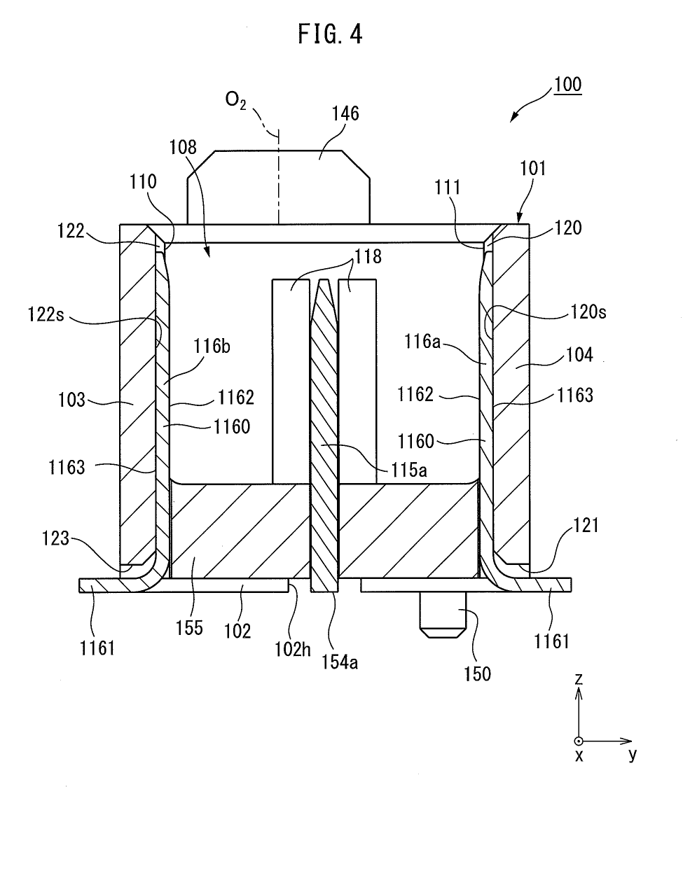

In the embodiment, a total of thirty signal contact mounting grooves 120 are formed on the inner surface 111. A through-hole 121 (see FIG. 4) extending through the side wall 104 in y-axis direction is formed on the end of each of the signal contact mounting grooves 120 in the negative z-axis direction.

A plurality of signal contact mounting grooves 122 (see FIG. 2A and FIG. 4) are formed on the inner surface 110 of the side wall 103 so as to align along x-axis direction. In the same manner as the signal contact mounting groove 120 described above, the signal contact mounting groove 122 is a groove formed to be concave from the inner surface 110 toward inward of the side wall 103 with a predetermined width, and extends along z-axis direction of the inner surface 110.

In the embodiment, in the same manner as the inner surface 111, a total of thirty signal contact mounting grooves 122 are formed on the inner surface 110 to align substantially equidistantly in x-axis direction. Further, a through-hole 123 extending through the side wall 103 in y-axis direction is formed on the end of each of the signal contact mounting grooves 122 in the negative z-axis direction.

On the other hand, the engaging unit 109 of the housing 101 has the same configuration as the engaging unit 108 described above. The engaging unit 109 is defined by an inner surface 130 of the side wall 103, an inner surface 131 of the side wall 104, an inner surface 132 of the lateral wall 105, and an inner surface 133 of the partition wall 107 on the negative x-axis side.

Ground plate mounting part 134 is formed on the inner surface 132 of the lateral wall 105. In the same manner as the ground plate mounting parts 118 and 124 described above, the ground plate mounting part 134 includes a pair of protrusions extending in z-axis direction to be separate from each other in y-axis direction. A through-hole 135 (see FIG. 2E) extending through the lateral wall 105 in x-axis direction is formed on the end of the ground plate mounting part 134 in the negative z-axis direction.

On the other hand, ground plate mounting part 136 is formed on the inner surface 133 of the partition wall 107. In the same manner as the ground plate mounting part 134, the ground plate mounting part 136 includes a pair of protrusions extending in z-axis direction to be separate from each other in y-axis direction. Further, a through-hole 137 (see FIG. 2A) extending through the partition wall 107 in x-axis direction is formed from the inner surface 133 to the opening 107h between the paired protrusions of the ground plate mounting part 136.

A total of thirty signal contact mounting grooves 140 are formed on the inner surface 131 of the side wall 104 to align substantially equidistantly in x-axis direction, in the same manner as the signal contact mounting grooves 120 described above. Further, a through-hole 141 (see FIG. 2C) extending through the side wall 104 in y-axis direction is formed on the end of each of the signal contact mounting grooves 140 in the negative z-axis direction.

On the other hand, a total of thirty signal contact mounting grooves 142 (see FIG. 2A) are formed on the inner surface 130 of the side wall 103 to align substantially equidistantly in x-axis direction, in the same manner as the signal contact mounting grooves 122 described above. Further, a through-hole 143 extending through the side wall 103 in y-axis direction is formed on the end of each of the signal contact mounting grooves 142 in the negative z-axis direction.

An engaging guide 145 is formed on an outer surface 106s of the lateral wall 106 of the housing 101 to project from the outer surface 106s in the positive x-axis direction. The engaging guide 145 includes a protrusion extending in z-axis direction with an asymmetrical shape with respect to the centerline of the lateral wall 106 in y-axis direction. The centerline O₁ (see FIG. 2D) of the engaging guide 145 in y-axis direction is displaced toward the negative y-axis direction with respect to the centerline of the lateral wall 106 in y-axis direction.

Likewise, an engaging guide 146 is formed on an outer surface 105s of the lateral wall 105 of the housing 101 to project from the outer surface 105s in the negative x-axis direction. The engaging guide 146 includes a protrusion extending in z-axis direction with an asymmetrical shape with respect to the centerline of the lateral wall 105 in y-axis direction. The centerline O₂ (see FIGS. 2A and 2E) of the engaging guide 146 in y-axis direction is displaced toward the negative y-axis direction with respect to the centerline of the lateral wall 105 in y-axis direction.

Further, a marginal part 147 is formed on the end of the outer surface 106s of the lateral wall 106 in the negative z-axis direction to extend from the outer surface 106s in the positive x-axis direction. The marginal part 147 is disposed on the positive y-axis side of the engaging guide 145. Further, a projection 148 (see FIGS. 2C and 2D) is disposed on the lower surface of the marginal part 147 to project in the negative z-axis direction.

Likewise, a marginal part 149 (see FIGS. 2A and 2E) is formed on the end of the outer surface 105s of the lateral wall 105 in the negative z-axis direction to extend from the outer surface 105s in the negative x-axis direction. The marginal part 149 is disposed on the positive y-axis side of the engaging guide 146. Further, a projection 150 (see FIGS. 2C and 2E) is formed on the lower surface of the marginal part 149 to project in the negative z-axis direction. The projections 148 and 150 are disposed on the positive y-axis side with respect to the center of the housing 101 in y-axis direction. The projections 148 and 150 described above are used for positioning the plug connector 100 when mounting the plug connector 100 on a substrate.

The ground contact 115 extends in parallel with the side walls 104 and 103. Specifically, the ground contact 115 includes a first ground contact 115a disposed in the engaging unit 108, and a second ground contact 115b disposed in the engaging unit 109. As illustrated in FIG. 3, the ground contact 115a is a flat plate member without a bent portion, and includes a flat plate part 151a of a rectangular shape as viewed in y-axis direction, and lead parts 152a and 153a respectively projecting from the flat plate part 151a in the positive x-axis direction and in the negative x-axis direction.

When viewed from x-axis direction, the flat plate part 151a has a tapering shape toward the end thereof in the positive z-axis direction (see FIG. 4). In the embodiment, only an end surface 154a of the flat plate part 151a in the negative z-axis direction is a fracture surface at the time of press molding, and the other surfaces of the flat plate part 151a are not fracture surfaces but roll surfaces.

The lead part 152a of the ground contact 115a extends in the positive x-axis direction from the end of the flat plate part 151a in the positive x-axis direction and in the negative z-axis direction. On the other hand, the lead part 153a extends in the negative x-axis direction from the end of the flat plate part 151a in the negative x-axis direction and in the negative z-axis direction. The lead parts 152a and 153a serve as portions to be subjected to reflow soldering and the like when the plug connector 100 is mounted on a substrate.

As illustrated in FIG. 1 and FIGS. 2A to 2E, the end of the flat plate part 151a in the positive x-axis direction is held between the paired protrusions of the ground plate mounting part 124 formed on the inner surface 112 of the lateral wall 106 in a state that the ground contact 115a is mounted in the engaging unit 108. Concurrently, the lead part 152a of the ground contact 115a is inserted through the through-hole 117 formed on the lateral wall 106.

On the other hand, the end of the flat plate part 151a in the negative x-axis direction is held between the paired protrusions of the ground plate mounting part 124 formed on the inner surface 113 of the partition wall 107. Concurrently, the lead part 153a of the ground contact 115a is inserted through the through-hole 119 formed on the inner surface 113 of the partition wall 107, and extends to the inside of the opening 107h formed on the partition wall 107.

According to the above configuration, when a user views the inside of the opening 107h from z-axis direction, the user is able to visually recognize the lead part 153a extending to the inside of the opening 107h (see FIG. 2A). Thus, the user is able to check the soldering state of the lead part 153a as a substrate connection portion through the opening 107h when mounting the plug connector 100 on a substrate.

Further, the end surface 154a of the flat plate part 151a projects to the outside from the housing via a hole 102h disposed on the bottom wall 102 (see FIG. 4). The end surface 154a serves as a portion to be subjected to reflow soldering and the like when mounting the plug connector 100 on a substrate.

The ground contact 115b has the same configuration as the ground contact 115a. Specifically, the ground contact 115b includes a flat plate part 151b, and lead parts 152b and 153b projecting from the flat plate part 151b. Further, only an end surface 154b of the flat plate part 151b in the negative z-direction is a fracture surface at the time of press molding, and the other surfaces of the flat plate part 151b are not fracture surfaces but roll surfaces.

As illustrated in FIG. 1 and FIGS. 2A to 2E, the end of the flat plate part 151b in the negative x-axis direction is held between the paired protrusions of the ground plate mounting part 134 formed on the inner surface 132 of the lateral wall 105 in a state that the ground contact 115b is mounted in the engaging unit 109. Concurrently, the lead part 153b of the ground contact 115b is inserted through the through-hole 135 formed on the lateral wall 105.

On the other hand, the end of the flat plate part 151b in the positive x-axis direction is held between the paired protrusions of the ground plate mounting part 136 formed on the inner surface 133 of the partition wall 107. Concurrently, the lead part 152b of the ground contact 115b is inserted through the through-hole 137 formed on the inner surface 133 of the partition wall 107, and extends to the inside of the opening 107h.

According to the above configuration, when a user views the inside of the opening 107h in the positive z-axis direction, the user is able to visually recognize the lead part 152b extending to the inside of the opening 107h (see FIG. 2A). Thus, the user is able to check the soldering state of the lead part 152b as a substrate connection portion when mounting the plug connector 100 on a substrate.

Further, the end surface 154b of the flat plate part 151b projects to the outside from the housing via the hole 102h disposed in the bottom wall 102. The end surface 154b serves as a portion to be subjected to soldering and the like when mounting the plug connector 100 on a substrate, in the same manner as the end surface 154a of the ground contact 115a.

The signal contacts 116 in the engaging unit 108 includes a first row of a plurality of signal contacts (first signal contacts) 116a aligned along the side wall 104, and a second row of a plurality of signal contacts (second signal contacts) 116b aligned along the side wall 103.

Further, the signal contacts 116 in the engaging unit 109 includes a first row of a plurality of signal contacts (first signal contacts) 116c aligned along the side wall 104, and a second row of a plurality of signal contacts (second signal contacts) 116d aligned along the side wall 103. In the embodiment, the signal contact 116 includes signal contacts 116a, 116b, 116c, and 116d each constituted by a total of thirty signal contacts.

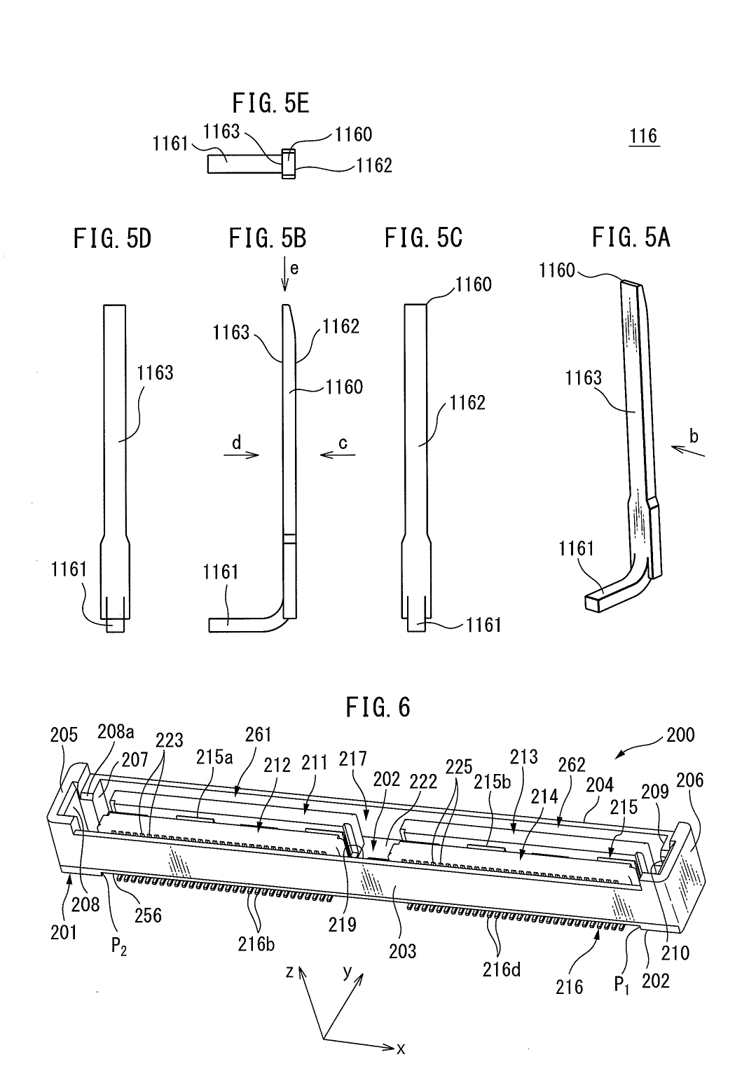

In the embodiment, each of the signal contacts 116 has the same shape as each other. In the following, a configuration of the signal contact 116 is described referring to FIGS. 5A to 5E. FIGS. 5A to 5E are external views of the signal contact 116. FIG. 5A is a perspective view of the signal contact 116.

Further, FIG. 5B is a diagram of the signal contact 116 illustrated in FIG. 5A as viewed from the arrow b in FIG. 5A. Further, FIG. 5C is a diagram of the signal contact 116 illustrated in FIG. 5B as viewed from the arrow c in FIG. 5B. Further, FIG. 5D is a diagram of the signal contact 116 illustrated in FIG. 5B as viewed from the arrow d in FIG. 5B.

Further, FIG. 5E is a diagram of the signal contact 116 illustrated in FIG. 5B as viewed from the arrow e in FIG. 5B. In the following description relating to FIGS. 5A and 5B, the lower side of FIG. 5B is referred to as a proximal end side, and the upper side of FIG. 5B is referred to as a distal end side. Further, the right side of FIG. 5B is referred to as a front side, and the left side of FIG. 5B is referred to as a back side.

The signal contact 116 is a pin member bent into a substantially L-shape. The signal contact 116 is provided with a main part 1160 linearly extending from a proximal end to a distal end thereof, and a lead part 1161 bent in a direction orthogonal to the main part 1160. The main part 1160 serves as a pin member of a rectangular shape in cross-section having a front surface 1162 and a back surface 1163, and is formed into a tapering shape toward the distal end. The lead part 1161 extends from the proximal end of the main part 1160 toward the back side.

Next, a mounting structure of the signal contacts 116 is described referring to FIG. 1 to FIG. 4. Each of the signal contacts 116a of the first row to be mounted in the engaging unit 108 is fixed in each of the signal contact mounting grooves 120 formed in the inner surface 111 of the side wall 104.

Specifically, as illustrated in FIG. 4, the signal contact 116a is fixed in the signal contact mounting groove 120 so that the main part 1160 of the signal contact 116a is pressingly inserted into the signal contact mounting groove 120 from the back surface 1163 thereof. Therefore, the width of the signal contact mounting groove 120 in x-axis direction is set to be slightly smaller than the width of the main part 1160 of the signal contact 116a in x-axis direction.

Consequently, the back surface 1163 of the main part 1160 of the signal contact 116a comes into contact with a bottom surface 120s of the signal contact mounting groove 120 substantially over the entirety of the bottom surface 120s in z-axis direction. On the other hand, the front surface 1162 of the main part 1160 is disposed so as to be closer to the ground contact 115a than the inner surface 111 of the side wall 104. Further, the lead part 1161 extends from the side wall 104 to the positive y-axis direction through the through-hole 121 formed on the side wall 104.

Likewise, each of the signal contacts 116b of the second row to be mounted in the engaging unit 108 is fixed in each of the signal contact mounting grooves 122 formed in the inner surface 110 of the side wall 103 so that the main part 1160 of the signal contact 116b is pressingly inserted into the signal contact mounting groove 122 from the back surface 1163 thereof.

Consequently, the back surface 1163 of the main part 1160 of the signal contact 116b comes into contact with a bottom surface 122s of the signal contact mounting groove 122 substantially over the entirety of the bottom surface 122s in z-axis direction. On the other hand, the front surface 1162 of the main part 1160 is disposed so as to be closer to the ground contact 115a than the inner surface 110 of the side wall 103. Further, the lead part 1161 extends from the side wall 103 to the negative y-axis direction through the through-hole 123 formed on the side wall 103.

Likewise, each of the signal contacts 116c of the first row to be mounted in the engaging unit 109 is fixed in each of the signal contact mounting grooves 140 formed in the inner surface 131 of the side wall 104 so that the main part 1160 of the signal contact 116c is pressingly inserted into the signal contact mounting grooves 140 form the back surface 1163 thereof. In performing the above operation, the lead part 1161 of the signal contact 116c extends from the side wall 104 to the positive y-axis direction through the through-hole 141 formed on the side wall 104.

Likewise, each of the signal contacts 116d of the second row to be mounted in the engaging unit 109 is fixed in each of the corresponding signal contact mounting grooves 142 formed in the inner surface 130 of the side wall 103 so that the main part 1160 of the signal contact 116d is pressingly inserted into the signal contact mounting groove 142 from the back surface 1163 thereof. In performing the above operation, the lead part 1161 of the signal contact 116d extends from the side wall 103 to the negative y-axis direction through the through-hole 143 formed on the side wall 103.

In the embodiment, as illustrated in FIG. 4, a sealing member 155 is introduced on the bottom wall 102 in the engaging unit 108 and engaging unit 109 in order to stably fix the ground contact 115 and the signal contacts 116. The ground contact 115 and the signal contacts 116 are stably fixed to the housing 101 by the sealing member 155.

As described above, in the plug connector 100 according to the embodiment, the ground contact 115a faces both of the first row of the signal contacts 116a and the second row of the signal contacts 116b so as to isolate the first row of the signal contacts 116a and the second row of the signal contacts 116b from each other. Further, the ground contact 115b faces both of the first row of the signal contacts 116c and the second row of the signal contacts 116d so as to isolate the first row of the signal contacts 116c and the second row of the signal contacts 116d from each other.

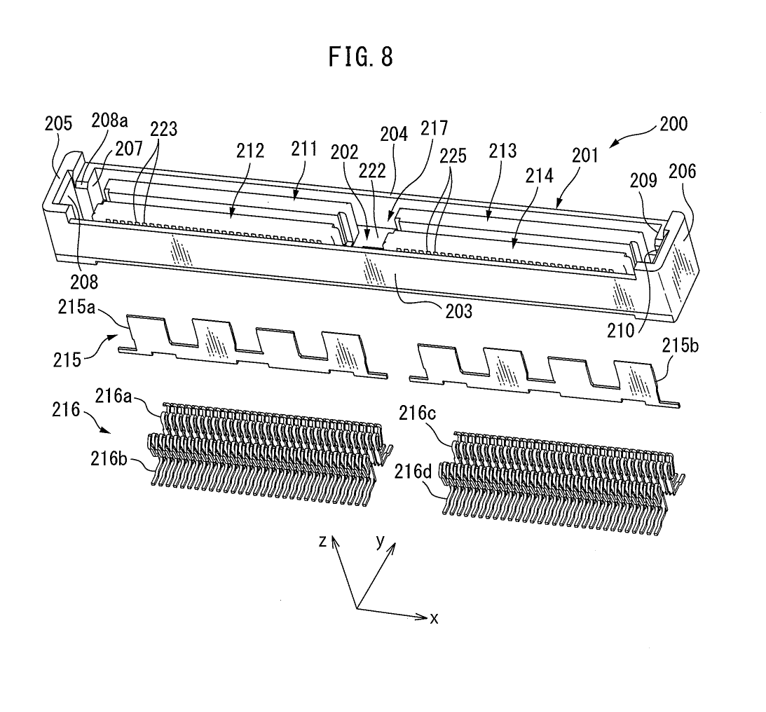

Next, a configuration of a jack connector 200 according to an embodiment of the invention is described referring to FIG. 6 to FIG. 9. In the following description, x-axis, y-axis, and z-axis are defined as illustrated in FIG. 6, and the directions indicated by the arrows of these axes are referred to as positive directions. The jack connector 200 is provided with a housing 201, ground contacts 215, and signal contacts 216. The ground contacts 215 and the signal contacts 216 are mounted on the housing 201.

The housing 201 is provided with a bottom wall 202, and outer side walls 203 and 204 disposed on both ends of the bottom wall 202 in y-axis direction and configured to extend along x-axis in parallel to each other. The outer side wall 203 is disposed separately from the outer side wall 204 on the negative y-axis side of the outer side wall 204.

Further, the housing 201 is provided with a lateral wall 205 orthogonally intersecting with both of the outer side walls 203 and 204 at the ends thereof in the negative x-axis direction, and a lateral wall 206 orthogonally intersecting with both of the outer side walls 203 and 204 at the ends thereof in the positive x-axis direction.

An engaging groove 208 is formed on an inner surface 207 of the lateral wall 205 of the housing 201 so as to be concave from the inner surface 207 toward inward of the lateral wall 205. The engaging groove 208 is formed into an asymmetrical shape with respect to the centerline of the lateral wall 205 in y-axis direction, and extends in z-axis direction.

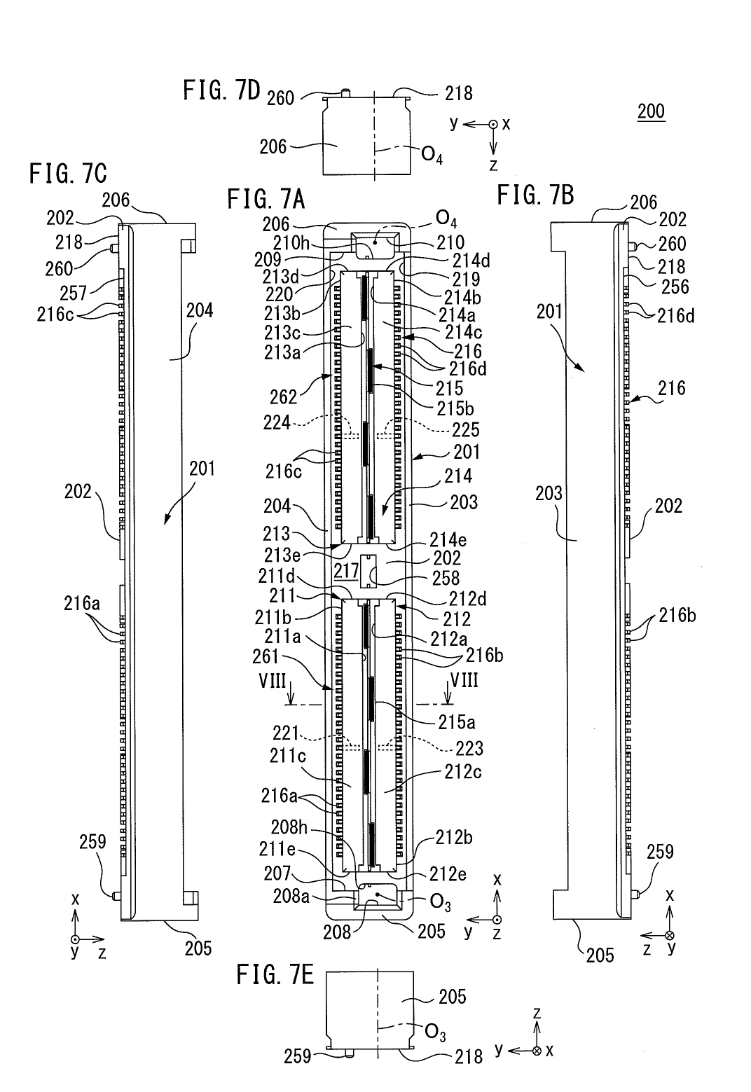

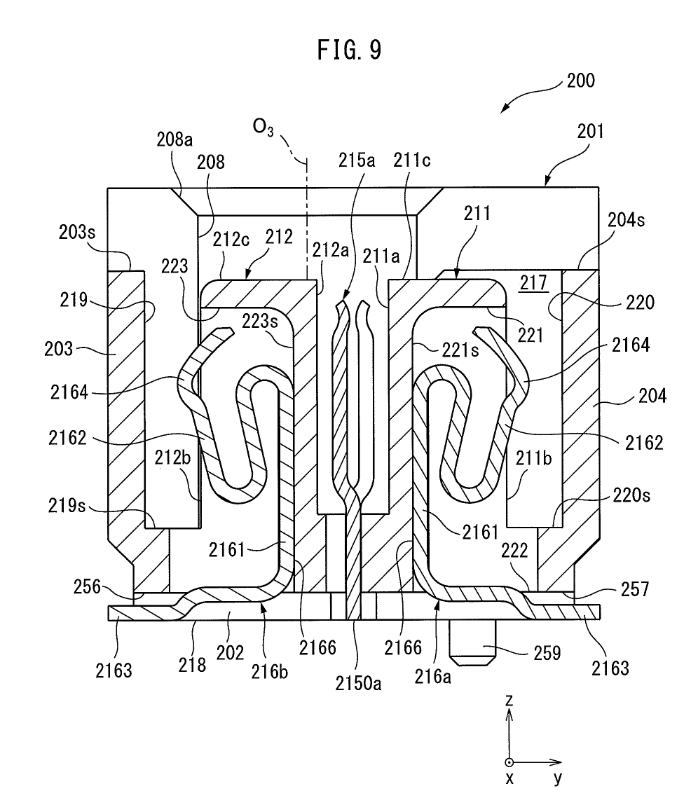

More specifically, the centerline O₃ (see FIG. 7E and FIG. 9) of the engaging groove 208 in y-axis direction is displaced toward the negative y-axis direction with respect to the centerline of the lateral wall 205 in y-axis direction. A chamfered part 208a configured to increase the width thereof in y-axis direction toward the positive z-axis direction is formed on the end of the engaging groove 208 in the positive z-axis direction. In the embodiment, the engaging groove 208 extends through the housing 201 in z-axis direction, and an opening 208h (see FIG. 7A) of a substantially rectangular shape as viewed in z-axis direction is formed on the bottom wall 202.

Likewise, an engaging groove 210 is formed on an inner surface 209 of the lateral wall 206 of the housing 201 so as to be concave from the inner surface 209 toward inward of the lateral wall 206. The engaging groove 210 is formed into an asymmetrical shape with respect to the centerline of the lateral wall 206 in y-axis direction, and extends in z-axis direction. More specifically, the centerline O₄ (see FIG. 7D) of the engaging groove 210 in y-axis direction is displaced toward the negative y-axis direction with respect to the centerline of the lateral wall 206 in y-axis direction. In the embodiment, the engaging groove 210 extends through the housing 201 in z-axis direction, and an opening 210h (see FIG. 7A) is formed on the bottom wall 202.

A step part 219s (see FIG. 9) to be described later is formed on the end of an inner surface 219 of the outer side wall 203 in the negative z-axis direction. Likewise, a step part 220s (see FIG. 9) to be described later is formed on the end of an inner surface 220 of the outer side wall 204 in the negative z-axis direction.

The housing 201 is provided with four inner side walls 211, 212, 213, and 214 extending in x-axis direction within a space 217 defined by the bottom wall 202, the outer side walls 203 and 204, and the lateral walls 205 and 206. The inner side wall 211 and the inner side wall 212 are disposed in the region on the negative x-axis side with respect to the center of the space 217 in x-axis direction. The inner side wall 211 and the inner side wall 212 extend along x-axis so as to face each other and to be parallel to the outer side wall 204 and the outer side wall 203.

As illustrated in FIGS. 7A to 7E and FIG. 9, the inner side wall 211 includes a side surface 211a and a side surface 211b extending in parallel to each other along x-axis, an upper surface 211c connected to the end edge of the side surface 211a and side surface 211b in the positive z-axis direction, an end surface 211d connected to the end edge of the side surface 211a and side surface 211b in the positive x-axis direction, and an end surface 211e connected to the end edge of the end surface 211a and side surface 211b in the negative x-axis direction.

The side surface 211a extends in parallel to the inner surface 220 of the outer side wall 204, and is disposed at a position slightly separate from the center of the housing 201 in y-axis direction toward the positive y-axis direction. The side surface 211b extends in x-axis direction so as to face the inner surface 220 at a position separate from the inner surface 220 of the outer side wall 204 toward the negative y-axis side by a predetermined distance.

The upper surface 211c extends in parallel to the inner surface 222 of the bottom wall 202, and is disposed at a substantially same position in the z-axis direction as an end surface 204s in the positive z-axis direction of the outer side wall 204 (more specifically, at a position slightly separate from the end surface 204s in the negative z-axis direction). The end surface 211d is a flat surface orthogonal to x-axis, and is disposed at a position slightly separate from the center of the housing 201 in x-axis direction toward the negative x-axis direction. Further, the end surface 211e is disposed at a position slightly separate from the inner surface 207 of the lateral wall 205 toward the positive x-axis direction.

A plurality of signal contact mounting grooves 221 (see FIG. 7A and FIG. 9) are formed on the side surface 211b of the inner side wall 211 so as to align along the side surface 211b. Each of the signal contact mounting grooves 221 is formed so as to be concave from the side surface 211b of the inner side wall 211 toward inward of the inner side wall 211, and extends in z-axis direction from the bottom wall 202 to a position near the upper surface 211c of the inner side wall 211. In the embodiment, a total of thirty signal contact mounting grooves 221 are formed to align substantially equidistantly in x-axis direction.

The inner side wall 212 is disposed on the negative y-axis side of the inner side wall 211. The inner side wall 211 and the inner side wall 212 are substantially symmetrical to each other with respect to the center of the housing 201 in y-axis direction. Specifically, the inner side wall 212 includes side surfaces 212a and 212b extending in parallel to each other along x-axis, an upper surface 212c connected to the end edge of the side surface 212a and side surface 212b in the positive z-axis direction, an end surface 212d connected to the end edge of the side surface 212a and side surface 212b in the positive x-axis direction, and an end surface 212e connected to the end edge of the end surface 212a and side surface 212b in the negative x-axis direction.

The side surface 212a extends in parallel to the inner surface 219 of the outer side wall 203, and is disposed at a position slightly separate from the center of the housing 201 in y-axis direction toward the negative y-axis direction. The side surface 212b extends so as to face the inner surface 219 at a position separate from the inner surface 219 of the outer side wall 203 toward the positive y-axis direction by a predetermined distance.

The upper surface 212c extends in parallel to the inner surface 222 of the bottom wall 202, and is disposed at a substantially same position in the z-axis direction as an end surface 203s in the positive z-axis direction of the outer side wall 203 (more specifically, at a position slightly separate from the end surface 203s in the negative z-axis direction). The end surface 212d is disposed on the same flat surface as the end surface 211d of the inner side wall 211. Further, the end surface 212e is disposed on the same flat surface as the end surface 211e of the inner side wall 211.

A plurality of signal contact mounting grooves 223 are formed on the side surface 212b of the inner side wall 212 so as to align along the side surface 212b. Each of the signal contact mounting grooves 223 is formed so as to be concave from the side surface 212b of the inner side wall 212 toward inward of the inner side wall 212, and extends in z-axis direction from the bottom wall 202 to a position near the upper surface 212c of the inner side wall 212. In the embodiment, a total of thirty signal contact mounting grooves 223 are formed to align substantially equidistantly in x-axis direction.

The inner side wall 213 and the inner side wall 214 are disposed in the region on the positive x-axis side with respect to the center of the space 217 in x-axis direction. The inner side wall 213 has the same configuration as the inner side wall 211 described above. Specifically, as illustrated in FIGS. 7A to 7E, the inner side wall 213 includes side surfaces 213a and 213b, an upper surface 213c, and end surfaces 213d and 213e. Further, a plurality of signal contact mounting grooves 224 are formed on the side surface 213b of the inner side wall 213 to align along the side surface 213b.

The inner side wall 214 has the same configuration as the inner side wall 212 described above. Specifically, as illustrated in FIGS. 7A to 7E, the inner side wall 214 includes side surfaces 214a and 214b, an upper surface 214c, and end surfaces 214d and 214e. Further, a plurality of signal contact mounting grooves 225 are formed on the side surface 214b of the inner side wall 214 to align along the side surface 214b.

An opening 256 is formed on the end of the outer side wall 203 of the housing 201 in the negative z-axis direction to extend from the first position P₁ (see FIG. 6) in x-axis direction over to the second position P₂ in x-axis direction. Likewise, an opening 257 is formed on the end of the outer side wall 204 of the housing 201 in the negative z-axis direction to extend from the first position in x-axis direction over to the second position in x-axis direction. Further, a rectangular opening 258 (see FIG. 7A) is formed in a region of the bottom wall 202 between the inner side walls 211 and 212, and the inner side walls 213 and 214.

A projection 260 (see FIGS. 7B to 7D) is formed on the end of an outer surface 218 (see FIGS. 7B to 7E and FIG. 9) of the bottom wall 202 in the positive x-axis direction to project from the outer surface 218 in the negative z-axis direction. Further, a projection 259 is formed on the end of the outer surface 218 of the bottom wall 202 in the negative x-axis direction to project from the outer surface 218 in the negative z-axis direction. The projections 260 and 259 are disposed at a position on the positive y-axis side with respect to the center of the housing 201 in y-axis direction. The projections 260 and 259 are used for positioning the jack connector 200 when mounting the jack connector 200 on a substrate.

The ground contacts 215 includes a first ground contact 215a disposed between the inner side wall 211 and the inner side wall 212 of the housing 201, and a second ground contact 215b disposed between the inner side wall 213 and the inner side wall 214 of the housing 201. The ground contacts 215a and 215b have the same shape.

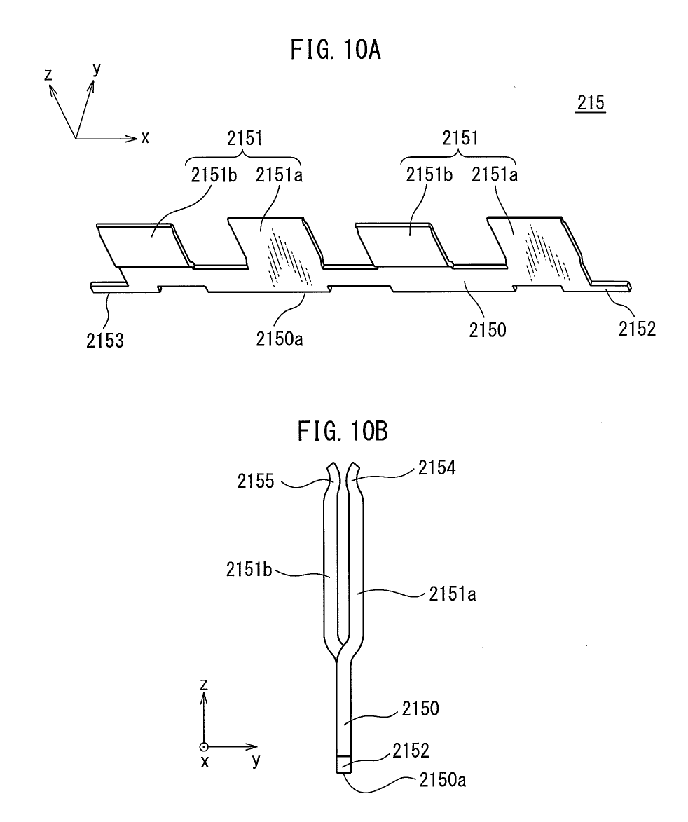

In the following, a configuration of the ground contact 215 is described referring to FIGS. 10A and 10B. The ground contact 215 is provided with a ground base part 2150 fixedly supported by the housing 201, and spring arms (ground arm) 2151 extending from the ground base part 2150 in the positive z-axis direction.

The ground base part 2150 extends along x-axis direction, and is held between the inner side wall 211 (213) and the inner side wall 212 (214) of the housing 201 at the end of the ground base part 2150 in the positive x-axis direction and at the end of the ground base part 2150 in the negative x-axis direction. The ground base part 2150 includes a lead part 2152 extending in the positive x-axis direction from the end of the ground base part 2150 in the positive x-axis direction, and a lead part 2153 extending in the negative x-axis direction from the end of the ground base part 2150 in the negative x-axis direction.

The ground contact 215 according to the embodiment is configured such that only the end surface 2150a of the base part in the negative z-axis direction is a fracture surface at the time of press molding, and the other surfaces of the ground contact 215 are not fracture surfaces but roll surfaces.

The spring arm 2151 includes a first spring arm 2151a extending from the ground base part 2150 and bent toward the positive y-axis side, and a second spring arm 2151b extending from the ground base part 2150 and bent toward the negative y-axis side. The spring arm 2151a and the spring arm 2151b are separate from each other in y-axis direction, as illustrated in FIG. 10B.

Further, as illustrated in FIG. 10A, the spring arm 2151a and the spring arm 2151b are alternately disposed to be separate from each other in x-axis direction. In the embodiment, two spring arms 2151a and two spring arms 2151b are provided so as to align alternately on one ground contact 215 in x-axis direction.

The spring arm 2151a has a contact point 2154 on the positive z-axis end of the spring arm 2151a so as to be curved toward the spring arm 2151b side. On the other hand, the spring arm 2151b has a contact point 2155 on the positive z-axis end of the spring arm 2151b so as to be curved toward the spring arm 2151a side.

As illustrated in FIG. 7A, the lead part 2152 of the ground contact 215a reaches the inside of the opening 258 formed in the center region of the bottom wall 202 in a state that the ground contact 215a is mounted between the inner side wall 211 and the inner side wall 212. Accordingly, a user is able to visually recognize the lead part 2152 extending into the opening 258 when the user views the opening 258 in z-axis direction. Thus, the user is able to check the soldering state of the lead part 2152 as a substrate connection portion when mounting the jack connector 200 on a substrate.

On the other hand, the lead part 2153 of the ground contact 215a reaches the inside of the opening 208h defined in the bottom wall 202 by the engaging groove 208. Accordingly, a user is able to visually recognize the lead part 2153 extending into the opening 208h when the user views the opening 208h in z-axis direction. Thus, the user is able to check the soldering state of the lead part 2153 as a substrate connection portion when mounting the jack connector 200 on a substrate.

Referring to FIG. 6 to FIG. 9, the signal contacts 216 includes a first row of a plurality of signal contacts (first signal contacts) 216a aligned along the side surface 211b of the inner side wall 211, and a second row of a plurality of signal contacts (second signal contacts) 216b aligned along the side surface 212b of the inner side wall 212.

Further, the signal contacts 216 includes a first row of a plurality of signal contacts (first signal contacts) 216c aligned along the side surface 213b of the inner side wall 213, and a second row of a plurality of signal contacts (second signal contacts) 216d aligned along the side surface 214b of the inner side wall 214. In the embodiment, the signal contacts 216 includes the signal contacts 216a, 216b, 216c, and 216d each constituted by a total of thirty signal contacts.

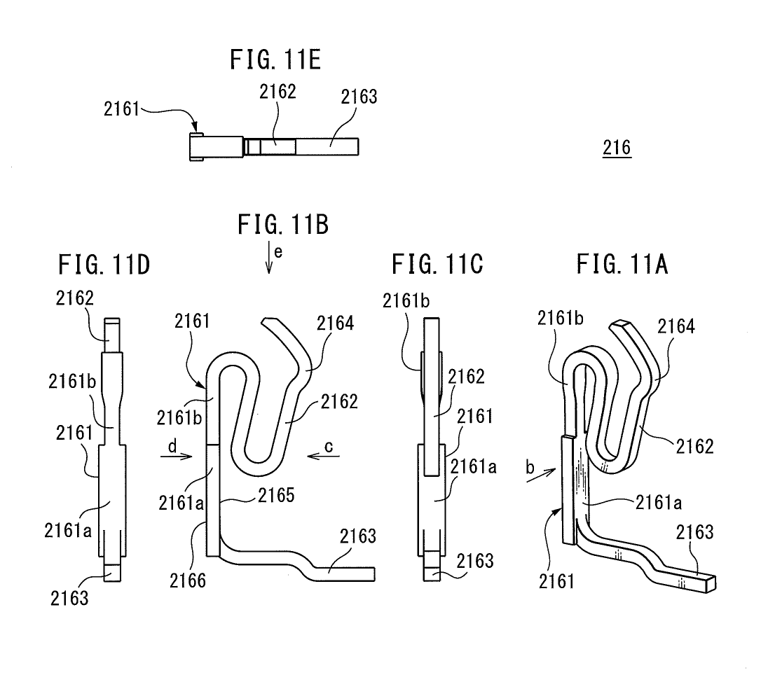

In the embodiment, each of the signal contacts 216 has the same shape. In the following, a configuration of the signal contact 216 is described referring to FIGS. 11A to 11E. FIGS. 11A to 11E are external views of the signal contact 216. FIG. 11A is a perspective view of the signal contact 216.

Further, FIG. 11B is a diagram of the signal contact 216 illustrated in FIG. 11A as viewed from the arrow b in FIG. 11A. Further, FIG. 11C is a diagram of the signal contact 216 illustrated in FIG. 11B as viewed from the arrow c in FIG. 11B. Further, FIG. 11D is a diagram of the signal contact 216 illustrated in FIG. 11B as viewed from the arrow d in FIG. 11B.

Further, FIG. 11E is a diagram of the signal contact 216 illustrated in FIG. 11B as viewed from the arrow e in FIG. 11B. In the following description relating to FIGS. 11A to 11B, the lower side of FIG. 11B is referred to as a proximal end side, and the upper side of FIG. 11B is referred to as a distal end side. Further, the right side of FIG. 11B is referred to as a front side, and the left side of FIG. 11B is referred to as a back side.

The signal contact 216 includes a base part 2161 linearly extending from a proximal end to a distal end thereof, a spring arm 2162 extending from the distal end of the base part 2161 toward the front side, and a lead part 2163 extending from the proximal end of the base part 2161 toward the front side.

The base part 2161 is a pin member of a rectangular shape in cross-section having a front surface 2165 and a back surface 2166, and includes a first part 2161a disposed on the proximal end side, and a second part 2161b disposed on the distal end side of the first part 2161a. As illustrated in FIG. 11D, the first part 2161a has a width larger than the second part 2161b.

The spring arm 2162 is formed on the distal end of the second part 2161b of the base part 2161. The spring arm 2162 is a pin member bent into a substantially U-shape as viewed in the direction illustrated in FIG. 11B. A contact point 2164 curved toward the front side is provided at the distal end of the spring arm 2162. The contact point 2164 is not a fracture surface at the time of press molding, but a roll surface. The spring arm 2162 has a smaller width than the first part 2161a as viewed in the direction illustrated in FIG. 11D.

When a force in the direction of the arrow c in FIG. 11B is applied to the contact point 2164, the spring arm 2162 is elastically deformed toward the direction c. As the spring arm 2162 is elastically deformed, the spring arm 2162 generates an elastic restoring force so as to push back the contact point 2164 in the direction of the arrow d in FIG. 11B.

Next, a mounting structure of the signal contact 216 is described referring to FIG. 6 to FIG. 9. Each of the signal contacts 216a of the first row aligned along the side surface 211b of the inner side wall 211 is fixed in each of the signal contact mounting grooves 221 formed on the side surface 211b. Specifically, as illustrated in FIG. 9, the signal contact 216a is fixed in the signal contact mounting grove 221 so that the base part 2161 of the signal contact 216a is pressingly inserted into the signal contact mounting grove 221 from the back surface 2166 thereof.

The width of the signal contact mounting groove 221 in x-axis direction is set to be slightly smaller than the width of the first part 2161a of the base part 2161 and to be slightly larger than the width of the second part 2161b of the base part 2161 and of the spring arm 2162. According to this configuration, when the signal contact 216a is pressingly inserted in the signal contact mounting groove 221, the first part 2161a of the base part 2161 is held and fixed by both of the wall surfaces of the signal contact mounting groove 221.

On the other hand, the second part 2161b of the base part 2161, and the spring arm 2162 connected to the second part 2161b have a smaller width than the signal contact mounting groove 221 in x-axis direction. Therefore, the second part 2161b and the spring arm 2162 are separated from both of the wall surfaces of the signal contact mounting groove 221 in x-axis direction. Thus, the second part 2161b and the spring arm 2162 are freely and elastically deformed in y-axis direction, even when the signal contact 216a is pressingly inserted in the signal contact mounting groove 221.

The back surface 2166 of the base part 2161 of the signal contact 216a comes into contact with a bottom surface 221s of the signal contact mounting groove 221 substantially over the entirety of the bottom surface 221s in z-axis direction in a state that the signal contact 216a is fixed in the signal contact mounting groove 221.

On the other hand, the contact point 2164 formed on the spring arm 2162 of the signal contact 216a is more projected in the positive y-axis direction than the side surface 211b of the inner side wall 211. Further, the lead part 2163 of the signal contact 216a extends from the outer side wall 204 in the positive y-axis direction via the opening 257 formed on the outer side wall 204.

Likewise, each of the signal contacts 216b of the second row aligned along the side surface 212b of the inner side wall 212 is fixed in each of the signal contact mounting grooves 223 formed in the side surface 212b so that the base part 2161 of the signal contact 216b is pressingly inserted into the signal contact mounting grooves 223 form the back surface 2166 thereof.

At this time, the second part 2161b and the spring arm 2162 of the signal contact 216b are freely and elastically deformed in y-axis direction. In this state, the back surface 2166 of the base part 2161 of the signal contact 216b comes into contact with a bottom surface 223s of the signal contact mounting groove 223 substantially over the entirety of the bottom surface 223s in z-axis direction.

On the other hand, the contact point 2164 formed on the spring arm 2162 of the signal contact 216b is more projected in the negative y-axis direction than the side surface 212b of the inner side wall 212. Further, the lead part 2163 of the signal contact 216b extends from the outer side wall 203 in the negative y-axis direction via the opening 256 formed on the outer side wall 203.

Likewise, each of the signal contacts 216c of the first row aligned along the side surface 213b of the inner side wall 213 is fixed in each of the signal contact mounting grooves 224 formed in the side surface 213b so that the base part 2161 of the signal contact 216c is pressingly inserted into the signal contact mounting groove 224 from the back surface 2166 thereof. At this time, the lead part 2163 of the signal contact 216c extends from the outer side wall 204 in the positive y-axis direction via the opening 257 formed on the outer side wall 204.

Likewise, each of the signal contacts 216d of the second row aligned along the side surface 214b of the inner side wall 214 is fixed in each of the signal contact mounting grooves 225 so that the base part 2161 of the signal contact 216d is pressingly inserted into the signal contact mounting groove 225 form the back surface 2166 thereof. At this time, the lead part 2163 of the signal contact 216d extends from the outer side wall 203 in the negative y-axis direction via the opening 256 formed on the outer side wall 203.

As described above, the inner side walls 211 and 212 support the ground contact 215a, and the signal contacts 216a and 216b, which are elements to be electrically connected to the counterpart connector to be connected. Therefore, the inner side walls 211 and 212 constitute a first engaging unit 261.

Further, the inner side walls 213 and 214 support the ground contact 215b, and the signal contacts 216c and 216d, which are elements to be electrically connected to the counterpart connector to be connected. Therefore, the inner side walls 213 and 214 constitute a second engaging unit 262.

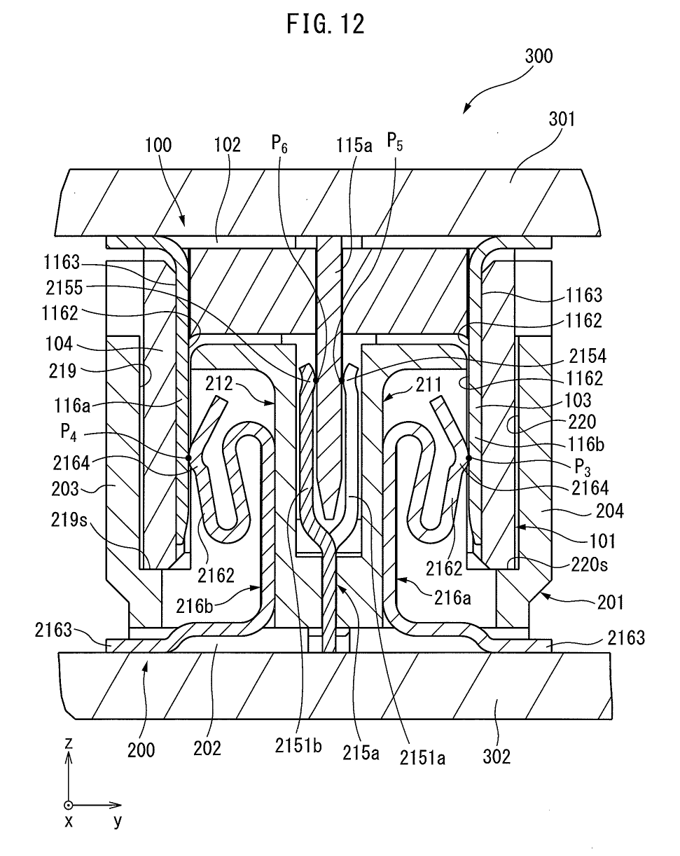

Next, a connector device 300 according to an embodiment of the invention is described referring to FIG. 12. FIG. 12 is a cross-sectional view of the connector device 300 taken along the line IV-IV in FIG. 2A (or the line VIII-VIII in FIG. 7A). The connector device 300 is provided with the plug connector 100 having the above-described configuration and the jack connector 200 having the above-described configuration.

In the state illustrated in FIG. 12, the engaging unit 108 of the plug connector 100 and the engaging unit 109 of the plug connector 100 are engaged with the engaging unit 261 of the jack connector 200 and the engaging unit 262 of the jack connector 200, respectively. Further, in the state illustrated in FIG. 12, the plug connector 100 and the jack connector 200 are mounted on a substrate 301 and a substrate 302, respectively.

In a state that the plug connector 100 is connected to the jack connector 200 as illustrated in FIG. 12, the engaging guide 145 (see FIGS. 2A to 2D) of the plug connector 100 is engaged with the engaging groove 208 (see FIG. 7A) of the jack connector 200, and the engaging guide 146 of the plug connector 100 is engaged with the engaging groove 210 of the jack connector 200.

As described above, the engaging guides 145 and 146, and the engaging grooves 208 and 210 respectively have asymmetrical shape to each other with respect to the center of the lateral wall in y-axis direction. According to this configuration, the direction of the plug connector 100 with respect to the jack connector 200 is uniquely determined when connecting the plug connector 100 to the jack connector 200. This makes it easy to connect the plug connector 100 to the jack connector 200.

When the plug connector 100 is connected to the jack connector 200, the side wall 104 of the plug connector 100 enters inside the outer side wall 203 of the jack connector 200, and the distal end of the side wall 104 abuts against the step part 219s formed on the inner surface 219 of the outer side wall 203. On the other hand, the side wall 103 of the plug connector 100 enters inside the outer side wall 204 of the jack connector 200, and the distal end of the side wall 103 abuts against the step part 220s formed on the inner surface 220 of the outer side wall 204. According to this configuration, movement of the plug connector 100 with respect to the jack connector 200 in z-axis direction is restricted.

The ground contact 115a of the plug connector 100 enters between the spring arm 2151a and the spring arm 2151b of the ground contact 215a of the jack connector 200. Then, the contact point 2154 of the spring arm 2151a comes into conductive contact with one side surface of the ground contact 115a of the plug connector 100 in y-axis direction at the contact point P₅.

Further, the contact point 2155 of the spring arm 2151b comes into conductive contact with the other side surface of the ground contact 115a of the plug connector 100 in y-axis direction at the contact point P₆. In this state, the spring arms 2151a and 2151b elastically deform outwardly and therefore hold the ground contact 115a from both sides thereof at the contact points P₅ and P₆.

On the other hand, the signal contact 216a of the jack connector 200 comes into conductive contact with the signal contact 116b of the plug connector 100. Specifically, the contact point 2164 disposed on the spring arm 2162 of the signal contact 216a comes into contact with the front surface 1162 of the signal contact 116b of the plug connector 100 at the contact point P₃. In this state, the spring arm 2162 of the signal contact 216a is elastically deformed inwardly. Therefore, the restoring force generated by the spring arm 2162 acts to press the front surface 1162 of the signal contact 116b at the contact point P₃.

Likewise, the signal contact 216b of the jack connector 200 comes into conductive contact with the signal contact 116a of the plug connector 100. Specifically, the contact point 2164 disposed on the spring arm 2162 of the signal contact 216b comes into conductive contact with the front surface 1162 of the signal contact 116a of the plug connector 100 at the contact point P₄. In this state, the spring arm 2162 of the signal contact 216b is elastically deformed inwardly. Therefore, the restring force generated by the spring arm 2162 acts to press the front surface 1162 of the signal contact 116a at the contact point P₄.

As described above, in the embodiment, when the plug connector 100 is connected to the jack connector 200, the signal contact 216 of the jack connector 200 is elastically deformed to thereby press the signal contact 116 of the plug connector 100. On the other hand, the signal contact 116 of the plug connector 100 is stably fixed on the side wall without elastic deformation.

According to the above configuration, the member which requires a space for allowing elastic deformation among the signal contacts is only the signal contact 216 (spring arm 2162) of the jack connector 200. It is not necessary to provide a space for elastic deformation of the signal contact 116 of the plug connector 100. Therefore, it is possible to make the structure of the signal contact 116 of the plug connector 100, and the mounting structure for mounting the signal contact 116 on the side wall to be compact.

Thus, the above configuration is advantageous in effectively miniaturizing the connector device 300, while securing stable conductive contact between the signal contact 216 of the jack connector 200 and the signal contact 116 of the plug connector 100.

Further, according to the embodiment, the spring arm 2151a and the spring arm 2151b of the ground contact 215 of the jack connector 200 are alternately disposed to be separate from each other in x-axis direction. According to this configuration, it is possible for the ground contact 215 of the jack connector 200 to contact at the contact points P₅ and P₆ on both side surfaces of the ground contact 115 of the plug connector 100. This configuration also enables to reduce the width of the ground contact 115 in y-axis direction. Accordingly, it is possible to miniaturize the jack connector 200 while securing stable conductive contact between the ground contact 215 of the jack connector 200 and the ground contact 115 of the plug connector 100. Further, according to the embodiment, when the plug connector 100 is connected to the jack connector 200, it is possible to isolate the signal contacts 116a and 216a of the first row, and the signal contacts 116b and 216b of the second row from each other by the ground contact 115 of the plug connector 100. This makes it possible to reduce crosstalk between the first row of the signal contacts and the second row of the signal contacts. Thus, the connector device 300 according to the embodiment is advantageously applied to a circuit board for high-speed transmission.

Further, according to the embodiment, the jack connector 200 is configured such that the signal contacts 216a of the first row and the ground contact 215a are isolated from each other by the inner side wall 211, and the signal contacts 216b of the second row and the ground contact 215a are isolated from each other by the inner side wall 212.

According to the above configuration, it is possible to secure insulation between the signal contact 216 and the ground contact 215, and to reduce crosstalk between the signal contacts 216a of the first row and the signal contacts 216b of the second row.

Further, according to the embodiment, each of the signal contacts 216 of the jack connector 200 is fixed in the housing 201 by pressingly inserting each of the signal contacts 216 to each of the corresponding signal contact mounting grooves 221, 223, 223, 224, 225 formed on the inner side walls 211, 212, 213, 214 of the housing 201. According to this configuration, it is possible to easily mount the signal contacts 216 in the housing 201, and to secure insulation between the signal contacts 216 adjacent to each other.

Further, according to the embodiment, the contact points P₅ and P₆ at which the ground contact 115 of the plug connector 100, and the ground contact 215 of the jack connector 200 come into contact with each other are disposed not on a fracture surface at the time of press molding, but on a roll surface. According to this configuration, it is possible to prevent from damaging the contact surfaces of the ground contact 115 and the ground contact 215 when the plug connector 100 is repeatedly taken in and out of the jack connector 200. This makes it possible to extend the life of the connector device 300 when the plug connector is repeatedly taken in and out of the jack connector.

Likewise, the contact points P₃ and P₄ at which the signal contact 116 of the plug connector 100, and the signal contact 216 of the jack connector 200 come into contact with each other are formed not on a fracture surface at the time of press molding, but on a roll surface. According to this configuration, it is possible to prevent from damaging the contact surfaces of the signal contact 116 and the signal contact 216. This makes it possible to extend the life of the connector device 300 when the plug connector is repeatedly taken in and out of the jack connector.

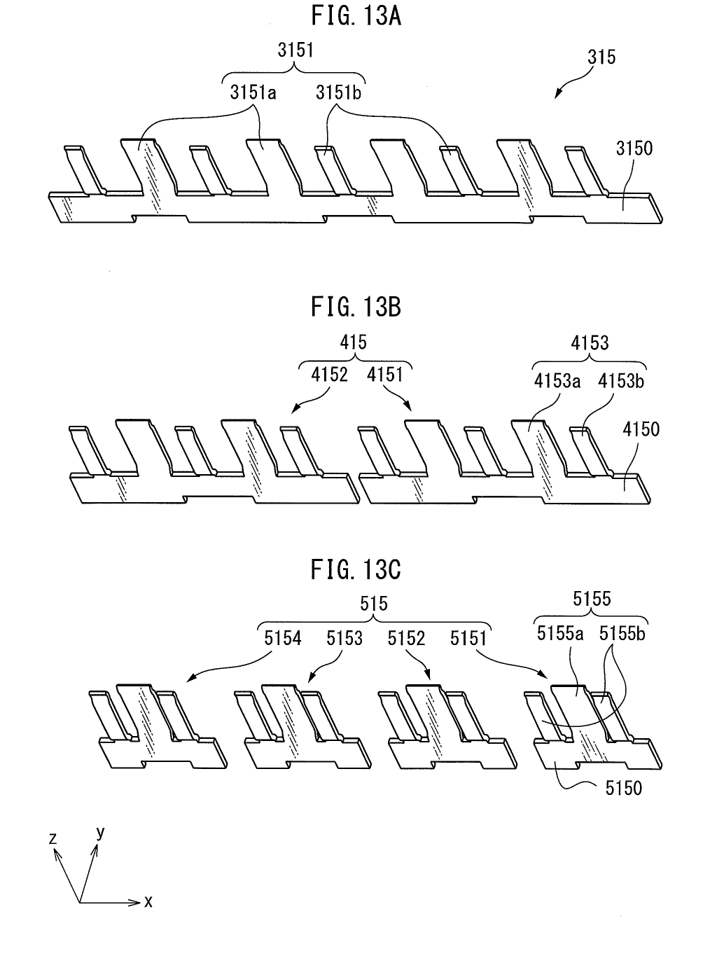

Next, ground contacts of the jack connector according to other embodiments of the invention are described referring to FIGS. 13A to 13C. The ground contacts illustrated in FIGS. 13A to 13C are described using the same xyz coordinate system as in FIGS. 10A and 10B. First of all, a ground contact 315 illustrated in FIG. 13A is described.

In the same manner as the foregoing embodiment, the ground contact 315 is fixedly supported on the housing 201 of the jack connector 200. The ground contact 315 is provided with a base part 3150 extending along x-axis, and a spring arm 3151 extending from the base part 3150 in the positive z-axis direction.

The spring arm 3151 includes a first spring arm 3151a extending from the base part 3150 and bent toward the positive y-axis side, and a second spring arm 3151b extending from the base part 3150 and bent toward the negative y-axis side.

In the embodiment, a total of four spring arms 3151a and a total of five spring arms 3151b are provided so as to alternately align on one ground contact 315 in x-axis direction. The length of each of the spring arms 3151a in x-axis direction is set to be longer than the length of each of the spring arms 3151b in x-axis direction.

Further, the length of the spring arm 3151a and spring arm 3151b in x-axis direction is set to be shorter than the length of the spring arm 2151 of the ground contact 215 illustrated in FIGS. 10A and 10B, and a larger number of spring arms 3151a and of spring arms 4151b are provided.

As described above, increasing the number of the spring arms 3151a and spring arms 3151b, and increasing the number of the contact points P₅ and P₅ with respect to the ground contact of the counterpart plug connector to be connected is advantageous in implementing stable signal transmission.

Next, a ground contact 415 illustrated in FIG. 13B is described. The ground contact 415 includes a first ground contact 4151 and a second ground contact 4152. The two ground contacts 4151 and 4152 have the same shape as each other, and are disposed to be separate from each other in x-axis direction in one engaging unit 261 (or 262) of the jack connector 200. Alternatively, it is possible to mount each of the ground contacts 4151 and 4152 on an engaging unit of a length shorter than the length of the engaging unit 261 (or 262) in x-axis direction, a one-half length, for example.

Each of the ground contacts 4151 and 4152 is provided with a base part 4150 and a spring arm 4153. The spring arm 4153 includes a first spring arm 4153a and a second spring arm 4153b. The spring arms 4153a and 4153b have the same shape as the spring arms 3151a and 3151b illustrated in FIG. 13A.

Next, a ground contact 515 illustrated in FIG. 13C is described. The ground contact 515 includes a first ground contact 5151, a second ground contact 5152, a third ground contact 5153, and a fourth ground contact 5154.

These four ground contacts 5151, 5152, 5153, and 5154 have the same shape as each other, and are disposed to be separate from each other in x-axis direction in one engaging unit 261 (or 262) of the jack connector 200. Alternatively, it is possible to mount each of the ground contacts 5151, 5152, 5153 and 5154 in an engaging unit of a length shorter than the length of the engaging unit 261 (or 262) in x-axis direction, a one-fourth length, for example.

Each of the ground contacts 5151, 5152, 5153, 5153, and 5154 is provided with a base part 5150 and a spring arm 5155. The spring arm 5155 includes a first spring arm 5155a and a second spring arm 5155b.

In the embodiment, one spring arm 5155a and a total of two spring arms 5155b are provided so as to align alternately on each of the ground contacts 5151, 5152, 5153, and 5154 in x-axis direction.

In the foregoing embodiments, a plug connector is provided with two engaging units, and a jack connector is provided with two engaging units, respectively. Alternatively, a plug connector may be provided with one, or more than two engaging units. Likewise, a jack connector may be provided with one, or more than two engaging units.

Further, in the foregoing embodiments, the first row of signal contacts and the second row of signal contacts each constituted by a total of thirty signal contacts are disposed in an engaging unit and in each of the engaging units. Alternatively, any number of signal contacts may be disposed in an engaging unit or in engaging units.

Further, in the foregoing embodiments, each of the signal contacts of the plug connector and jack connector is constituted by a pin member. Alternatively, each of the signal contacts of the plug connector and jack connector may be constituted by a plate-shaped member extending in x-axis direction, for example.

Further, in the foregoing embodiments, each of the signal contacts of the plug connector is fixed by pressingly inserting the signal contact to a signal contact mounting groove formed in the inner surface of a side wall. Alternatively, each of the signal contacts of the plug connector may be adhesively fixed to the inner surface of a side wall, or may be fixed by any other method.

Further, in the foregoing embodiments, each of the signal contacts of the jack connector is fixed by pressingly inserting the signal contact to a signal contact mounting groove formed in the side surface, facing the outer wall surface, of the inner side wall of the housing. Alternatively, each of the signal contacts of the jack connector may be adhesively fixed to a side surface of the inner side wall, or may be fixed by any other method.

Thus, the inner side wall of the jack connector is not necessarily provided with a signal contact mounting groove. For example, a plate-shaped member extending in x-axis direction may be provided to isolate the ground contact and the signal contact of the jack connector from each other.

Further, in the foregoing embodiments, an engaging guide is provided on a housing of the plug connector, and an engaging groove is provided in a housing of the jack connector. Alternatively, an engaging groove may be provided in a housing of a plug connector, and an engaging guide may be provided on a housing of a jack connector.

The invention has been described by way of the embodiments of the invention. The foregoing embodiments, however, do not limit the invention according to the claims. All the combinations of the features described in the embodiments may not be essential as means for solving problems in the invention. Further, it is obvious to those skilled in the art that a variety of modifications or improvements can be added to the embodiments. It is obvious that such modifications or improvements may also be included in the technical scope of the invention, as defined in the claims of the invention.

1. A jack connector, comprising:
a housing including a first inner wall, a second inner wall, a first outer wall extending parallel to the first inner wall, and a second outer wall extending parallel to the second inner wall;
first signal contacts aligned along the first inner wall on a side facing the first outer wall;
second signal contacts aligned along the second inner wall on a side facing the second outer wall; and
a ground contact disposed between the first inner wall and the second inner wall, and configured to come into conductive contact with a ground contact of a counterpart connector, wherein
each of the first signal contacts comprises:
a first base part fixedly supported by the first inner wall; and
a first arm extending from the first base part and including a contact point on the side facing the first outer wall, the contact point coming into conductive contact with a signal contact of the counterpart connector, and wherein
each of the second signal contacts comprises:
a second base part fixedly supported by the second inner wall; and
a second arm extending from the second base part and including a contact point on the side facing the second outer wall, the contact point coming into conductive contact with a signal contact of the counterpart connector.

2. The jack connector according to claim 1, wherein
the ground contact comprises:
a ground base part fixedly supported by the housing; and
ground arms extending from the ground base part so as to be separate from each other in a direction along the ground base part, each of the ground arms including a contact point which comes into contact with the ground contact of the counterpart connector, wherein
each of the ground arms includes:
a first ground arm extending from the ground base part so as to be bent toward a side close to the first inner wall, the first ground arm coming into conductive contact with the ground contact of the counterpart connector on the side facing the second inner wall; and
a second ground arm extending from the ground base part so as to be bent toward a side close to the second inner wall, the second ground arm coming into conductive contact with the ground contact of the counterpart connector on the side facing the first inner wall.

3. The jack connector according to claim 1, wherein
the housing further comprises a lateral wall orthogonally intersecting with both of the first outer wall and the second outer wall, and wherein
the lateral wall is provided with a groove extending in a height direction of the lateral wall, the groove being formed into an asymmetrical shape with respect to a centerline in a width direction of the lateral wall.

4. The jack connector according to claim 1, wherein
the housing further comprises:
engaging units, each of which includes the first inner wall and the second inner wall; and
a bottom wall formed between the adjacent engaging units, wherein
the first signal contacts, the second signal contacts, and the ground contact are disposed in each of the engaging units, and wherein
the bottom wall is provided with an opening extending through the bottom wall.
